(19) United States
(12) Patent Application Publication
(10) Pub. No.: US 2025/0319809 A1
(43) Pub. Date: Oct. 16, 2025

(54) RELEASABLY MOUNTABLE FURNITURE AND ROAD VEHICLE

(71) Applicant: MOOR-ROOM OY, Helsinki (FI)

(72) Inventor: Mika KORHONEN, Helsinki (FI)

(21) Appl. No.: 18/869,911

(22) PCT Filed: Jun. 2, 2023
(86) PCT No.: PCT/FI2023/050319

§ 371 Date: Nov. 27, 2024

(30) Foreign Application Priority Data
Jun. 3, 2022 (FI) 20225490

(51) Int. Cl. B60P 7/08; B60N 2/30; B60N 3/00; B60R 5/00; B62D 25/16; B62D 33/04

(52) U.S. Cl. CPC B60P 7/0815; B60N 2/30; B60N 3/001; B60R 5/00; B62D 25/16; B62D 33/04

(57) ABSTRACT

A road vehicle including a furniture, one or more prefabricated cargo fixing parts provided to the floor of the road vehicle and one or more connecting parts. The furniture is releasably mounted to the one or more prefabricated cargo fixing parts. The invention further relates to the furniture, use of one or more prefabricated cargo fixing parts for releasably mounting a furniture and use of the furniture as a releasably mounted table or shelf or chair or cabinet in a road vehicle.

### FIELD OF THE INVENTION

The present invention relates to a releasably mountable furniture and more particularly to a releasably mountable furniture according to the preamble of claim 1.

The present invention further relates to a road vehicle and more particularly to a road vehicle according to the preamble of claim 12.

The present invention further relates to a use of one or more prefabricated cargo fixing parts and more particularly to a use of one or more prefabricated cargo fixing parts according to the preamble of claim 17.

The present invention further relates to a use a of a furniture and more particularly to a use of a furniture according to the preamble of claim 19.

### BACKGROUND OF THE INVENTION

In the prior art several types of furniture are attached to road vehicles having a cargo space. Especially, wheel wells which limit use of the cargo space are covered with furniture. Typically, the furniture is fixed to the road vehicle with screws.

One of the problems associated with the prior art is that the structures of the road vehicle having screws or screw holes when furniture of a road vehicle is regularly adapted for different logistic tasks or the furniture is changed by a new owner or user. This is especially problem for vans which are used for different logistic tasks.

### BRIEF DESCRIPTION OF THE INVENTION

An object of the present invention is to provide a releasably mountable furniture, a road vehicle, a use of one or more prefabricated cargo fixing parts and a use a of a furniture so as to overcome or at least alleviate the prior art disadvantages.

The objects of the invention are achieved by a releasably mountable furniture which is characterized by what is stated in the independent claim 1.

The objects of the invention are further achieved by a road vehicle which is characterized by what is stated in the independent claim 12.

The objects of the invention are further achieved by a use of one or more prefabricated cargo fixing parts which is characterized by what is stated in the independent claim 17.

The objects of the invention are further achieved by a use a of a furniture which is characterized by what is stated in the independent claim 19.

The preferred embodiments of the invention are disclosed in the dependent claims.

The invention is based on the idea of providing a releasably mountable furniture arranged to be mounted to a road vehicle comprising a floor and one or more prefabricated cargo fixing parts provided to the floor of the road vehicle. The furniture comprises a first wall arranged to be positioned in a horizontal direction, a first vertical support arranged to be positioned in a vertical direction, a second vertical support arranged to be positioned in a vertical direction, a first mounting arrangement arranged to be releasably mounted to the one or more prefabricated cargo fixing parts of the road vehicle, and a second mounting arrangement arranged to be releasably mounted to the one or more prefabricated cargo fixing parts of the road vehicle. The first vertical support comprises a first bottom end and a first top end at distance from the first bottom end, the first vertical support extending between the first bottom end and the first top end. The first vertical support comprising a first bottom support surface provided to the first bottom end, the first bottom support surface is arranged to be releasably supported on the floor of the road vehicle. The second vertical support comprises a second bottom end and a second top end at distance from the second bottom end, the second vertical support extending between the second bottom end and the second top end. The second vertical support comprising a second bottom support surface provided to the second bottom end, the second bottom support surface is arranged to be releasably supported on the floor of the road vehicle. The first vertical support is connected to the first wall at a fifth vertical distance from the first bottom support surface. The second vertical support is connected to the first wall at a sixth vertical distance from the second bottom support surface. The second vertical support is arranged to be positioned at a sixth horizontal distance from the first vertical support.

In one embodiment, the furniture being a road vehicle furniture.

In one embodiment, the furniture being a piece of furniture.

In one embodiment, the furniture comprises a first hinge and a second hinge, the first hinge is arranged to provide a pivotable connection between the first vertical support and the first wall, and the second hinge is arranged to provide a pivotable connection between the second vertical support and the first wall.

This enables collapse the furniture when it is not used in vehicle and thus, less space is required for storage.

In an alternative embodiment, the furniture comprises a first hinge and a second hinge, the first hinge is arranged to provide a pivotable connection between the first vertical support and the first wall, the second hinge is arranged to provide a pivotable connection between the second vertical support and the first wall, the first vertical support further comprises a first upper surface provided to the first top end, the second vertical support further comprises a second upper surface provided to the second top end, the first wall comprises a first wall upper surface and a first wall lower surface at a distance from the first wall upper surface, the first wall lower surface is arranged to be positioned facing downwards and the first wall upper surface is arranged to be positioned facing upwards, the first upper surface of the first vertical support is arranged to be supported on the first wall lower surface and the second upper surface of the second vertical support is arranged to be supported on the first wall lower surface.

This enables collapse the furniture when it is not used in vehicle and thus, less space is required for storage and fast installation of the furniture.

In another alternative embodiment, the furniture comprises a first hinge and a second hinge, the first hinge is arranged to provide a pivotable connection between the first vertical support and the first wall, and the second hinge is arranged to provide a pivotable connection between the second vertical support and the first wall, the first wall further comprises a first side surface and a second side surface, the first wall extending between the first side surface and the second side surface, the first wall is arranged to extend or arranged be extended between the first vertical support and the second vertical support, the first side surface of the first wall is arranged to be supported on the first vertical support and the second side surface of the first wall is arranged to be supported on the second vertical support.

This enables collapse the furniture when it is not used in vehicle and thus, less space is required for storage and fast installation of the furniture.

In one embodiment, the first wall comprises a first side surface of the first wall, a second side surface of the first wall, the second side surface extending at a distance from the first side surface, the first side surface and the second side surface of the first wall extending between the first wall upper surface and the first wall lower surface, the first upper surface of the first vertical support is arranged to be positioned to extend between the first hinge and the first side surface of the first wall and the second upper surface of the second vertical support is arranged to be positioned to extend between the second hinge and the second side surface of the first wall.

This enables collapse the furniture when it is not used in vehicle and thus, less space is required for storage and fast installation of the furniture.

In an alternative embodiment, the first comprises a first side surface of the first wall, a second side surface of the first wall, the second side surface extending at a distance from the first side surface, the first side surface and the second side surface of the first wall extending between the first wall upper surface and the first wall lower surface, the first upper surface of the first vertical support is arranged to be positioned to extend between the first hinge and the first side surface of the first wall in the vicinity of the first side surface of the first wall, and the second upper surface is arranged to be positioned to extend between the second hinge and the second side surface of the first wall in the vicinity of the second side surface.

This enables collapse the furniture when it is not used in vehicle and thus, less space is required for storage and fast installation of the furniture.

In another alternative embodiment, the first wall comprises a first side surface of the first wall, a second side surface of the first wall, the second side surface extending at a distance from the first side surface, the first side surface and the second side surface of the first wall extending between the first wall upper surface and the first wall lower surface, the first upper surface is arranged to be positioned to extend between the first hinge and the second side surface of the first wall in the vicinity of the first side surface of the first wall, and the second upper surface is arranged to be positioned to extend between the second hinge and the first side surface of the first wall in the vicinity of the second side surface of the first wall.

This enables collapse the furniture when it is not used in vehicle and thus, less space is required for storage and fast installation of the furniture.

In one embodiment, the first vertical support comprises a first vertical support front surface, the second vertical support comprises a second vertical support front surface, the a first vertical support front surface is arranged to face or arranged to be positioned to face towards the second vertical support, the second vertical support front surface is arranged to face or arranged to be positioned to face towards the first vertical support, the first mounting arrangement is connected to the first vertical support front surface, and the second mounting arrangement is connected to the second vertical support front surface.

This means that the first wall covers and, thus protects the first mounting arrangement and the second mounting arrangement.

In an alternative embodiment, the first vertical support comprises a first vertical support front surface, the second vertical support comprises a second vertical support front surface, the a first vertical support front surface is arranged to face or arranged to be positioned to face in a direction away from the second vertical support, the second vertical support front surface is arranged to face or arranged to be positioned to face in a direction away from the first vertical support, the first mounting arrangement is connected to the first vertical support front surface, and the second mounting arrangement is connected to the second vertical support front surface.

In one embodiment, the first mounting arrangement is provided to the first vertical support, and the second mounting arrangement is provided to the second vertical support.

This means that the first vertical support and the second vertical support may be connected to the road vehicle.

In an alternative embodiment, the first mounting arrangement and the second mounting arrangement are provided to the first wall.

This means that the first wall may be connected to the road vehicle.

In another alternative embodiment, the first mounting arrangement is provided to the first vertical support, and the second mounting arrangement is provided to the second vertical support, the first mounting arrangement is provided at a first vertical distance from the first bottom support surface and the second mounting arrangement is at a second vertical distance from the second bottom support surface.

Thus, the first vertical support and the second vertical support may be connected to the road vehicle with one or more connecting parts so that the one or more connecting parts being flexible and having a tension force.

In a yet another alternative embodiment, the first mounting arrangement is provided to the first vertical support, and the second mounting arrangement provided to the second vertical support, the first vertical support having a first centre line extending in a direction between the first bottom support surface and first upper surface, the first hinge and the first mounting arrangement are positioned on the same side of the first centre line in a direction between the first vertical support and the second vertical support.

This increases bending moment resistance of the connection between the furniture and the road vehicle.

In a further alternative embodiment, the first mounting arrangement is provided to the first vertical support, and the second mounting arrangement is provided to the second vertical support, the first vertical support having a first centre line extending in a direction between the first bottom support surface and first upper surface, a first hinge and the first mounting arrangement are positioned on the same side of the first centre line in a direction between the first vertical support and second vertical support, the second vertical support having a second centre line extending in a direction between the second bottom support surface and the second upper surface, the second hinge and the second mounting arrangement are positioned on the same side of the second centre line in a direction between the first vertical support and second vertical support, the first mounting arrangement is provided at a first vertical distance from the first bottom support surface and the second mounting arrangement is at a second vertical distance from the second bottom support surface.

This increases bending moment resistance of the connection between the furniture and the road vehicle and the first vertical support and the second vertical support may be connected to the road vehicle with one or more connecting parts so that the one or more connecting parts being flexible and having a tension force.

In the context of this application a road vehicle means a vehicle designed solely or principally for use in transport on public roads.

In one embodiment, the furniture further comprises a second wall pivotably connected to the first wall, the second wall extending in a direction between the first side surface and the second side surface of the first wall.

That provides a large surface which is convenient to store.

In another embodiment, the furniture further comprises a second wall connected to the first wall, the second wall is arranged to be positioned to extend horizontally in a direction between the first side surface and the second side surface of the first wall.

This provides a large surface which is convenient to store.

In an alternative embodiment, the furniture further comprises a second wall pivotably connected to the first wall, a third wall pivotably connected to the second wall, and the second wall and the third wall extending in a direction between the first side surface and the second side surface of the first wall.

This provides a large surface with additional vertical support so that storing of the furniture is convenient.

In another alternative embodiment, the furniture further comprises a third hinge, a fourth hinge, a second wall and a third wall, and the third wall extending in a direction between the first side surface and the second side surface of the first wall the second wall is pivotably connected to the first wall with the third hinge and the third wall is pivotably connected to the second wall with the fourth hinge.

This provides a large surface with additional vertical support so that storing of the furniture is convenient and installing the furniture is simple.

In a yet another alternative embodiment, the furniture further comprises a third hinge, a fourth hinge, a second wall and a third wall, and the second wall and the third wall extending in a direction between the first side surface and the second side surface of the first wall, the second wall is pivotably connected to the first wall with the third hinge and the third wall is pivotably connected to the second wall with the fourth hinge, the third wall comprises a third wall bottom surface and a third wall top surface, the third wall further extending between the third wall bottom surface and the third wall top surface, the third wall bottom surface is arranged to be supported on the floor of the road vehicle and the third wall top surface is arranged to supported on the second wall.

This provides a large surface with additional vertical support so that storing of the furniture is convenient and installing the furniture is simple.

In one embodiment, the furniture further comprises a fourth wall pivotably connected to the first wall, the fourth wall extending in a direction between the first side surface and the second side surface of the first wall.

The fourth wall provides an additional storage space under the furniture.

In an alternative embodiment, the furniture further comprises a fourth wall pivotably connected to the first wall and a fifth hinge, the fourth wall extending in a direction between the first side surface and the second side surface of the first wall, the fourth wall is pivotably connected to the first wall with the fifth hinge, the fourth wall comprises a fourth wall bottom surface and a fourth wall top surface, the fourth wall further extending between the fourth wall bottom surface and the fourth wall top surface, the fourth wall bottom surface is arranged to be supported on the floor of the road vehicle and the third wall top surface is arranged to supported the first wall lower surface.

The fourth wall provides an additional storage space under the furniture and an additional support to the first wall.

In one embodiment, the first wall being a plate.

In an alternative embodiment, the first wall, the first vertical support and the second vertical support being plates.

In another alternative embodiment, the first wall, the second wall, the third wall, the first vertical support and the second vertical support being plates.

In a yet another alternative embodiment, the first wall, the second wall, the third wall, the fourth wall, the first vertical support and the second vertical support being plates.

Plates are structures which increases stability of the furniture.

In one embodiment, the plate being a metal plate, a polymer plate or a wood plate or plate made of material originated from wood.

In one embodiment, the plate is made of a metal, a polymer or a wood or material originated from wood.

In one embodiment, the furniture being a table, a shelf or a chair, or a cabinet or any combination thereof.

This furniture is especially advantageous to cover a wheel well.

In one embodiment, the furniture further comprises a horizontal support.

In an alternative embodiment, the furniture further comprises a horizontal support, the first vertical support and the second vertical support are arranged to be connected with the horizontal support.

In another alternative embodiment, the furniture further comprises a horizontal support arranged to be connected to a prefabricated part of a wall of the road vehicle.

The horizontal support increases a horizontal stability of the furniture.

In one embodiment, the furniture further comprises a third mounting arrangement provided to the first wall.

In an alternative embodiment, the furniture further comprises a third mounting arrangement provided to the first wall, the furniture having a third centre line extending in a direction between the first vertical support and the second vertical support, the third mounting arrangement is provided to an opposite side of the third centre line than the first mounting arrangement and the second mounting arrangement.

The third mounting arrangement increases a horizontal stability of the furniture.

The present invention relates also to road vehicle. The road vehicle comprises a furniture, one or more prefabricated cargo fixing parts provided to the floor of the road vehicle and one or more connecting parts. The furniture is releasably mounted to the one or more prefabricated cargo fixing parts. The furniture comprises a first wall, the first wall extending in a horizontal direction. The furniture comprises a first vertical support, the first vertical support extending in a vertical direction The furniture comprises a second vertical support, the second vertical support extending in a vertical direction. The furniture comprises a first mounting arrangement, the first mounting arrangement is releasably mounted to the one or more prefabricated cargo fixing part of the road vehicle with the one or more connecting parts. The furniture comprises a second mounting arrangement is releasably mounted to the one or more prefabricated cargo fixing part of the road vehicle with the one or more connecting parts. The first vertical support comprises a first bottom end and a first top end at distance from the first bottom end. The first vertical support comprising a first bottom support surface provided to first bottom end the first bottom support surface is releasably supported on the floor of the road vehicle. The second vertical support comprises a second bottom end and a second top end at distance from the second bottom end. The second vertical support comprises a second bottom support surface provided to the second bottom end, the second bottom support surface is releasably supported on the floor of the road vehicle. The first vertical support is connected to the first wall at a fifth vertical distance from the first bottom support surface. The second vertical support is connected to the first wall at a sixth vertical distance from the second bottom support surface. The second vertical support is positioned at a sixth horizontal distance from the first vertical support.

In one embodiment, the first bottom support surface is releasably supported against the floor of the road vehicle and the second bottom support surface is releasably supported against the floor of the road vehicle.

In one embodiment, the road vehicle comprises a wheel well and a vehicle wall, the wheel well is provided in the vicinity of the vehicle wall, and the first wall is provided over the wheel well.

Thus, the first wall provides a useful space over the wheel well.

In an alternative embodiment, the one or more connecting parts are secured to the one or more prefabricated cargo fixing parts between the first vertical support and the second vertical support.

Thus, the one or more connecting parts are covered and protected with the furniture.

In another embodiment, the one or more connecting parts are connected to the one or more prefabricated cargo fixing parts.

Thus, the one or more connecting parts are covered and protected with the furniture.

In another alternative embodiment, the road vehicle comprises a wheel well and a vehicle wall, the wheel well is provided in the vicinity of the vehicle wall, the first wall is provided over the wheel well, and the one or more connecting parts are secured to the one or more prefabricated cargo fixing parts between the first vertical support and the second vertical support.

Thus, the first wall provides a useful space over the wheel well so that the one or more connecting parts are covered and protected with the furniture.

In a yet another alternative embodiment, the road vehicle comprises a wheel well and a vehicle wall, the wheel well is provided in the vicinity of the vehicle wall, the first wall is provided over the wheel well, the one or more connecting parts are secured to the one or more prefabricated cargo fixing parts between the first vertical support and the second vertical support, the furniture further comprises a third mounting arrangement provided to the first wall at a first distance from the vehicle wall, the first mounting arrangement is provided at a second distance from the vehicle wall, the second mounting arrangement is provided at a third distance from the vehicle wall, the first distance being greater than the second distance, and the first distance being greater than the third distance.

Thus, the first wall provides a useful space over the wheel well so that the one or more connecting parts are covered and protected with the furniture and stability of the furniture is increased.

In one embodiment, the road vehicle further comprises a vehicle wall and one or more wall connecting parts arranged to mount the furniture to the vehicle wall.

This increases horizontal support of the furniture.

In another embodiment, the road vehicle further comprises a vehicle wall comprising a frame and one or more wall connecting parts, and the one or more wall connecting parts are arranged to mount the furniture to the frame of the vehicle wall.

This increases horizontal support of the furniture and the frame of the vehicle wall provides an easy way to secure the one or more wall connecting parts to the vehicle.

In an alternative embodiment, the road vehicle further comprises a vehicle wall and one or more wall connecting parts arranged to mount the furniture to the vehicle wall, the furniture comprises one or more wall mounting arrangements, the road vehicle further comprise one or more prefabricated wall cargo fixing parts provided to the wall, the one or more wall connecting parts being flexible and the one or more wall connecting parts comprise a tightening part and the one or more wall connecting parts are arranged to connect the one or more wall mounting arrangements to the one or more prefabricated wall cargo fixing parts provided to the wall.

This increases horizontal support of the furniture.

In yet another embodiment, the road vehicle further comprises a vehicle wall comprising a frame and one or more wall connecting parts, and the one or more wall connecting parts comprises a magnet attached against the wall.

Magnet is simple way to provide connection without screws.

In one embodiment, the one or more connecting parts being flexible.

This enables a simply connection between the furniture and the road vehicle so that the furniture may be connected to one or more prefabricated cargo fixing parts having different positions.

In another embodiment, the one or more connecting parts comprises one or more connecting rails.

The one or more connecting rails provides a rigid joint between the road vehicle and the furniture.

In an alternative embodiment, one or more connecting parts being flexible and the one or more connecting parts comprise a tightening part.

This enables a simple connection between the furniture and the road vehicle so that the furniture may be connected to one or more prefabricated cargo fixing parts having different positions and providing easily a tension force to the one or more connection parts.

In another alternative embodiment, the first mounting arrangement and the second mounting arrangement are provided above the one or more prefabricated cargo fixing parts.

This enables connect the furniture to the road vehicle with the one or more connection parts.

In a yet another alternative embodiment, the first mounting arrangement and the second mounting arrangement are provided above the one or more prefabricated cargo fixing parts and the one or more connecting parts being flexible.

This enables connect the furniture to the road vehicle with a tension force of the one or more connection parts.

In a further another alternative embodiment, the first mounting arrangement and the second mounting arrangement are provided above the one or more prefabricated cargo fixing parts, the one or more connecting parts being flexible and the one or more connecting parts comprise a tightening part.

This enables connect the furniture to the road vehicle with a tension force of the one or more connection parts and easily provide the one or more connection parts with a tension force.

In one embodiment, the furniture being any above disclosed embodiment of the furniture.

In one embodiment, the road vehicle being a van or a trailer.

Vans and trailers have typically one or more prefabricated cargo fixing parts in a and wheel wells limit use of the cargo space.

In one embodiment, the road vehicle being a van.

Vans are typically used for delivering several types of goods which should be organized in different ways in a van.

In one embodiment, the one or more prefabricated cargo fixing parts comprises one or more loops, or one or more hooks or one or more rails or any combination thereof.

In an alternative embodiment, the one or more prefabricated cargo fixing parts comprise one or more prefabricated holes provided to the floor of vehicle.

In another alternative embodiment, the one or more prefabricated cargo fixing parts comprise prefabricated holes comprising a screw thread provided to the floor of vehicle.

In one embodiment, the one or more prefabricated cargo fixing parts are provided to the road vehicle in a manufacturing site.

In one embodiment, the one or more prefabricated wall cargo fixing parts are installed to a wall of the road vehicle in a manufacturing site.

The present invention relates also to a use of one or more prefabricated cargo fixing parts provided to a floor of a road vehicle for releasably mounting a furniture to the vehicle, the furniture being a furniture according to anyone of above disclosed embodiment of the furniture.

In one embodiment, the road vehicle being a road vehicle according to anyone above disclosed embodiment of the road vehicle.

The present invention relates also to a use of a furniture according to anyone of above disclosed embodiment of the furniture as a releasably mounted table, shelf or chair or cabinet in a road vehicle.

In one embodiment, the road vehicle being a road vehicle according to anyone above disclosed embodiment of the road vehicle.

An advantage of the invention is that it provides a furniture which may be connected to a road vehicle without compromising any structure of the road vehicle. Furthermore, the present invention provides a road vehicle comprising a furniture so that the road vehicle does not have any screws or screw holes when the furniture is removed. Furthermore, installing and removing the furniture is simple. The furniture is especially advantageous to cover a wheel well of the road vehicle. Furthermore, the present invention provides a furniture such that the furniture of a road vehicle may be adapted for different logistic tasks without compromising an inner surface of the road vehicle.

### BRIEF DESCRIPTION OF THE DRAWINGS

The invention is described in detail by means of specific embodiments with reference to the enclosed drawings, in which

FIG. 1 shows schematically a front view of a furniture according to one embodiment of the present invention;

FIG. 2 shows schematically a front view of a furniture according to one embodiment of the present invention;

FIG. 3 shows schematically a bottom view of a furniture according to one embodiment of the present invention;

FIG. 4 shows schematically a side view of a furniture according to one embodiment of the present invention;

FIG. 5 shows schematically a side view of a furniture according to one embodiment of the present invention;

FIG. 6 shows schematically a front view of a furniture of a road vehicle according to one embodiment of the present invention;

FIG. 7 shows schematically a front view of a furniture of a road vehicle according to one embodiment of the present invention;

FIG. 8 shows schematically a bottom view of a furniture of a road vehicle according to one embodiment of the present invention;

FIG. 9 shows schematically a bottom view of a furniture of a road vehicle according to one embodiment of the present invention;

FIG. 10 shows schematically a front view of a furniture of a road vehicle according to one embodiment of the present invention; and

FIG. 11 shows schematically a front view furniture of a road vehicle according to one embodiment of the present invention

### DETAILED DESCRIPTION OF THE INVENTION

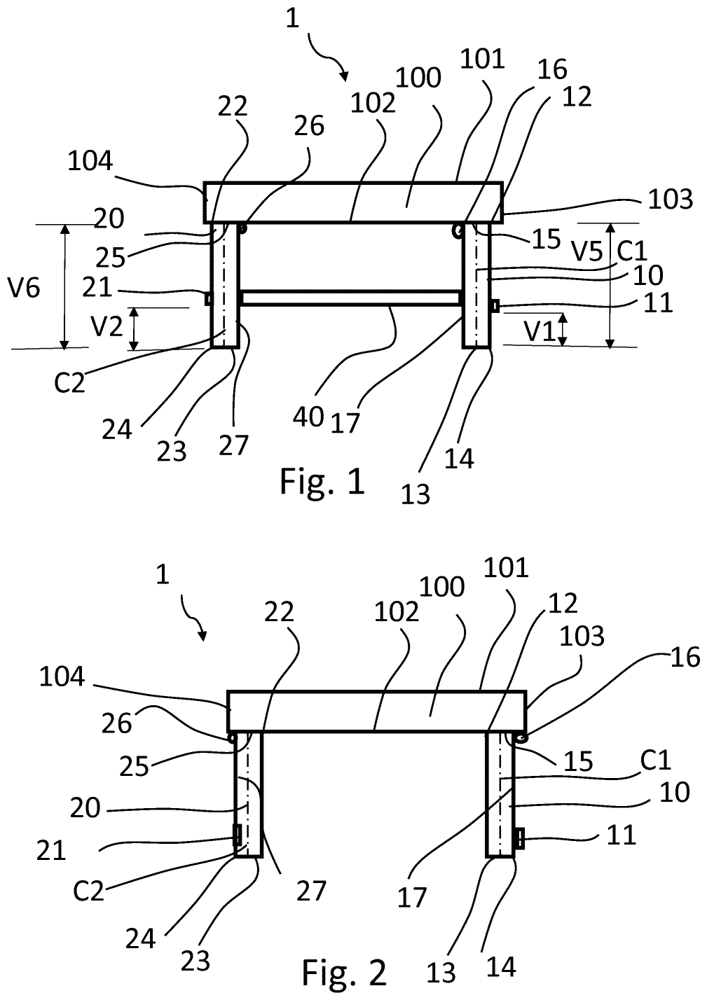

FIG. 1 shows schematically a front view of a releasably mountable furniture 1 according to one embodiment of the present invention.

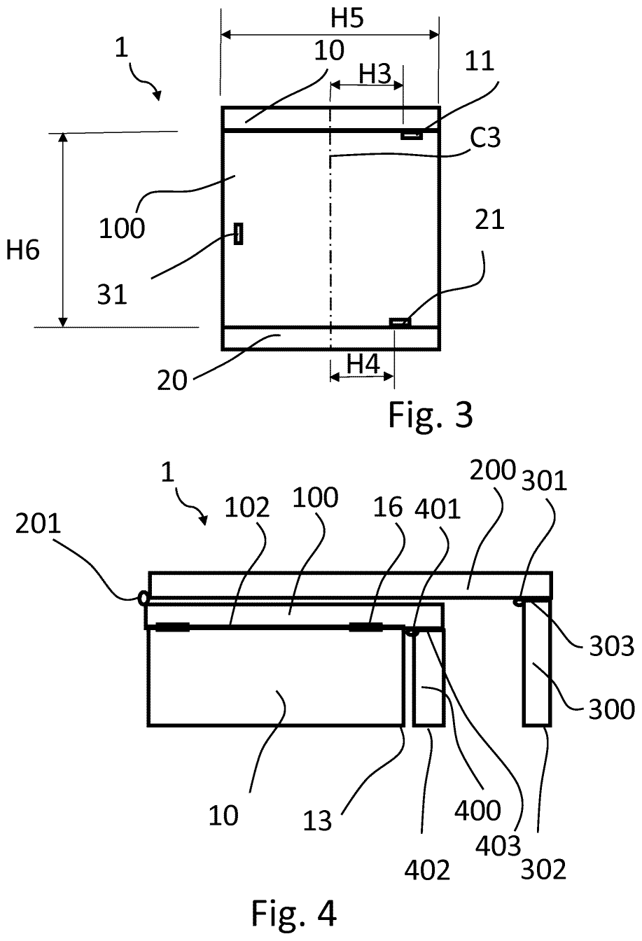

The releasably mountable furniture 1 arranged to be mounted to a road vehicle 500 comprising a floor 502 and one or more prefabricated cargo fixing parts 501 provided to the floor 502 of the road vehicle 500. The furniture 1 comprises a first wall 100 arranged to be positioned in a horizontal direction, a first vertical support 10 arranged to be positioned in a vertical direction, a second vertical support 20 arranged to be positioned in a vertical direction, a first mounting arrangement 11 arranged to be releasably mounted to the one or more prefabricated cargo fixing parts of the road vehicle 500, a second mounting arrangement 21 arranged to be releasably mounted to the one or more prefabricated cargo fixing parts of the road vehicle 500, the first vertical support 10 comprises a first bottom end 14 and a first top end 12 at distance from the first bottom end 14, the first vertical support 10 extending between the first bottom end 14 and the first top end 12. The first vertical support 10 comprising a first bottom support surface 13 provided to the first bottom end 14, the first bottom support surface 13 is arranged to be releasably supported on the floor 502 of the road vehicle 500, the second vertical support 20 comprises a second bottom end 24 and a second top end 25 at distance from the second bottom end 24, the second vertical support 20 extending between the second bottom end 24 and the second top end 25, the second vertical support 20 comprising a second bottom support surface 23 provided to the second bottom end 24, the second bottom support surface 23 is arranged to be releasably supported on the floor 502 of the road vehicle 500, the first vertical support 10 is connected to the first wall 100 at a fifth vertical distance V5 from the first bottom support surface 13. The second vertical support 20 is connected to the first wall 100 at a sixth vertical distance V6 from the second bottom support surface 23. The second vertical support 20 is arranged to be positioned at a sixth horizontal distance H6 from the first vertical support 10 (the sixth horizontal distance is shown in FIG. 3).

The fifth vertical distance V5 being a distance in a direction between the first bottom end 14 and the first top end 12.

The sixth vertical distance V6 being a distance in a direction between the second bottom end 24 and the second top end 22.

In other words, the fifth vertical distance V5 extending in a direction between the first bottom end 14 and the first top end 12.

In other words, the sixth vertical distance V6 extending in a direction between the second bottom end 24 and the second top end 22.

In the context of this application horizontal and a horizontal direction mean a direction which has angle between-15 degrees and 15 degrees with the ground level. In the context of this application vertical and a vertical mean a direction which has angle between 75 degrees and 105 degrees with the ground level.

In one embodiment, the second vertical support 20 and the first vertical support 10 are integrated. In other words, the second vertical support 20 and the first vertical support 10 are provided to one part.

In one embodiment, the second vertical support 20 and the first vertical support 10 are portions of a circular part.

In one embodiment, the first vertical support is secured to the first wall with one or more screws, and the second vertical support is secured to the first wall with one or more screws.

This provides a strong connection between the first wall and the first vertical support, and a strong connection between the first wall and the second vertical support.

In alternative embodiment, the first vertical support is secured to the first wall with an interlocking joint, and the second vertical support is secured to the first wall with an interlocking joint.

In the context of this application, an interlocking joint means a joint in which a protrusion on one member complements a slot or routed groove in another.

In one embodiment, the furniture 1 comprises a first hinge 16 and a second hinge 26, the first hinge 16 is arranged to provide a pivotable connection between the first vertical support 10 and the first wall 100, and the second hinge 26 is arranged to provide a pivotable connection between the second vertical support 20 and the first wall 100.

In one embodiment, the first vertical support 10 further comprises a first upper surface 15 provided to the first top end 12, the second vertical support 20 further comprises a second upper surface 25 provided to the second top end 22, the first wall 100 comprises a first wall upper surface 101 and a first wall lower surface 102 at a distance from the first wall 100 upper surface, the first wall lower surface 102 is arranged to be positioned facing downwards and the first wall upper surface 101 is arranged to be positioned facing upwards, the first upper surface 15 of the first vertical support 10 is arranged to be supported on the first wall lower surface 102 and the second upper surface 25 of the second vertical support 20 is arranged to be supported on the first wall lower surface 102.

In one embodiment, the furniture 1 comprises a first hinge 16 and a second hinge 26, the first hinge 16 is arranged to provide a pivotable connection between the first vertical support 10 and the first wall 100, and the second hinge 26 is arranged to provide a pivotable connection between the second vertical support 20 and the first wall 100, the first wall 100 further comprises a first side surface 103 and a second side surface 104, the first wall 100 extending between the first side surface 103 and the second side surface 104, the first wall 100 is arranged to extend or arranged be extended between the first vertical support 10 and the second vertical support 20, the first side surface 103 of the first wall 100 is arranged to be supported on the first vertical support 10 and the second side surface 104 of the first wall 100 is arranged to be supported on the second vertical support 20.

In the context of this application a hinge means a mechanical bearing that connects two solid objects, allowing an angle of rotation between them. Two objects connected with the hinge rotate relative to each other about a fixed axis of rotation.

In one embodiment, the first mounting arrangement 11 is provided to the first vertical support 10, and the second mounting arrangement 21 provided to the second vertical support 20.

In an alternative embodiment, the first mounting arrangement 11 and the second mounting arrangement 21 are provided to the first wall 100 (not shown in the FIG. 1).

In one embodiment, the first wall 100 comprises a first side surface 103 of the first wall 100, a second side surface 104 of the first wall 100, the second side surface 104 extending at a distance from the first side surface 103, the first side surface 103 and the second side surface 104 of the first wall 100 extending between the first wall upper surface 101 and the first wall lower surface 102, the first upper surface 15 of the first vertical support 10 is arranged to be positioned to extend between the first hinge 16 and the first side surface 103 of the first wall 100 and the second upper surface 25 of the second vertical support 20 is arranged to be positioned to extend between the second hinge 26 and the second side surface 104 of the first wall 100.

In one embodiment, the first upper surface 15 of the first vertical support 10 is arranged to be positioned to extend between the first hinge 16 and the first side surface 103 of the first wall 100 in the vicinity of the first side surface 103 of the first wall 100, and the second upper surface 25 is arranged to be positioned to extend between the second hinge 26 and the second side surface 104 of the first wall 100 in the vicinity of the second side surface 104.

In one embodiment, the first mounting arrangement 11 is provided to the first vertical support 10, and the second mounting arrangement 21 provided to the second vertical support 20, the first mounting arrangement 11 is provided at a first vertical distance V1 from the first bottom support surface 13 and the second mounting arrangement 21 is at a second vertical distance V2 from the second bottom support surface 23.

In one embodiment, the first vertical distance V1 being equal to the second vertical distance V2.

In an alternative embodiment, the first vertical distance V1 being unequal to the second vertical distance V2.

In one embodiment, the first mounting arrangement 11 is provided between the first wall 100 and the first bottom support surface 13, and the second mounting arrangement 21 is provided between the first wall 100 and the second bottom support surface 23.

In one embodiment, the furniture 1 being a table, a shelf, or a chair, or a cabinet or any combination thereof. In one embodiment, the furniture 1 further comprises a horizontal support 40.

In one embodiment, the first vertical support 10 and the second vertical support 20 are arranged to be connected with the horizontal support.

In an alternative embodiment, the furniture 1 further comprises a horizontal support 40 arranged to be connected to a prefabricated part of a wall of the road vehicle 500.

In one embodiment, the first hinge 16 is arranged to transfer a pulling force and a pushing force between the first vertical support 10 and the first wall 100, and the first upper surface 15 is arranged to provide a support to a pushing force between the first vertical support 10 and the first wall 100.

In other words, the first hinge 16 and the first upper surface 15 are arranged to carry a bending moment between the first vertical support 10 and the first wall 100.

In an alternative embodiment, the first hinge 16 is arranged to transfer a pulling force and a pushing force between the first vertical support 10 and the first wall 100, and the first side surface 103 of the first wall 100 is arranged to provide a support to a pushing force between the first vertical support 10 and the first wall 100.

In other words, the first hinge 16 and the first side surface 103 are arranged to carry a bending moment between the first vertical support 10 and the first wall 100.

In one embodiment, the second hinge 26 is arranged to transfer a pulling force and a pushing force between the second vertical support 20 and the first wall 100, and the second upper surface 25 is arranged to provide a support to a pushing force between the second vertical support 20 and the first wall 100.

In other words, the second hinge 16 and the second upper surface 25 are arranged to carry a bending moment between the second vertical support 20 and the first wall 100.

In one embodiment, the second hinge 26 is arranged to transfer a pulling force and a pushing force between the second vertical support 20 and the first wall 100, and the second side surface 104 of the first wall 100 is arranged to provide a support to a pushing force between the second vertical support 20 and the first wall 100.

In other words, the second hinge 26 and the second side surface 104 are arranged to carry a bending moment between the second vertical support 20 and the first wall 100.

FIG. 2 shows schematically a front view of a releasably mountable furniture 1 according to one embodiment of the present invention.

In one embodiment, the first vertical support 10 comprises a first vertical support front surface 17, the second vertical support 20 comprises a second vertical support front surface 27, the a first vertical support front surface 17 is arranged to face or arranged to be positioned to face in a direction away from the second vertical support 20, the second vertical support front surface 27 is arranged to face or arranged to be positioned to face in a direction away from the first vertical support 10, the first mounting arrangement 11 is connected a first vertical support front surface 17, and the second mounting arrangement 21 is connected the second vertical support front surface 27.

In an alternative embodiment, the first vertical support 10 comprises a first vertical support front surface 17, the second vertical support 20 comprises a second vertical support front surface 27, the a first vertical support front surface 17 is arranged to face or arranged to be positioned to face towards the second vertical support 20, the second vertical support front surface 27 is arranged to face or arranged to be positioned to face towards the first vertical support 10, the first mounting arrangement 11 is connected a first vertical support front surface 17, and the second mounting arrangement 21 is connected the second vertical support front surface 27 (not shown in the FIG. 2).

In one embodiment, the first wall 100 comprises a first side surface 103 of the first wall 100, a second side surface 104 of the first wall 100, the second side surface 104 extending at a distance from the first side surface 103, the first side surface 103 and the second side surface 104 of the first wall 100 extending between the first wall upper surface 101 and the first wall lower surface 102, the first upper surface 15 is arranged to be positioned to extend between the first hinge 16 and the second side surface 104 of the first wall 100 in the vicinity of the first side surface 103 of the first wall 100, and the second upper surface 25 is arranged to be positioned to extend between the second hinge 26 and the first side surface 103 of the first wall 100 in the vicinity of the second side surface 104 of the first wall 100.

In one embodiment, the first mounting arrangement 11 is provided to the first vertical support 10, and the second mounting arrangement 21 is provided to the second vertical support 20, the first vertical support 10 having a first centre line C1 extending in a direction between the first bottom support surface 13 and first upper surface 15, the first hinge 16 and the first mounting arrangement 11 are positioned on the same side of the first centre line C1 in a direction between the first vertical support 10 and the second vertical support 20.

FIG. 3 shows schematically a bottom view of a furniture according to one embodiment of the present invention.

In one embodiment, the furniture 1 further comprises a third mounting arrangement 31 provided to the first wall 100.

In one embodiment, the furniture 1 having a third centre line C3 extending in a direction between the first vertical support 10 and the second vertical support 20, the third mounting arrangement 31 is provided to an opposite side of the third centre line C3 than the first mounting arrangement 11 and the second mounting arrangement 21.

In one embodiment, the furniture 1 having a first width H5 in a direction perpendicular to the third centre line C3, the first mounting arrangement 11 is provided at a third horizontal distance H3 from the third centre line C3, the second mounting arrangement 21 is provided at a fourth horizontal distance H4 from the third centre line C3. It should be noted that the third horizontal distance H3 and the fourth horizontal distance H4 are shortest distances from the third centre line C3.

In one embodiment, the fourth horizontal distance H4 and the third horizontal distance H3 are between 0 and 0,25 times the first width H5 or between 0 and 0,4 times the first width H5 or between 0,25 and 0,5 times the first width H5.

FIG. 4 shows schematically a side view of a furniture according to one embodiment of the present invention.

In one embodiment, the furniture 1 further comprises a second wall 200 pivotably connected to the first wall 100, the second wall 200 extending in a direction between the first side surface 103 and the second side surface 104 of the first wall 100.

In one embodiment, the furniture 1 further comprises a third wall 300 pivotably connected to the second wall 200, and the second wall 200 and the third wall 300 extending in a direction between the first side surface 103 and the second side surface 104 of the first wall 100.

In one embodiment, the furniture 1 further comprises the second side surface 104 of the first wall 100 the second wall 200 is pivotably connected to the first wall 100 with the third hinge 201 and the third wall 300 is pivotably connected to the second wall 200 with the fourth hinge 301.

In one embodiment, the furniture 1 further comprises a third hinge 201, a fourth hinge 301, a second wall 200 and a third wall 300, and the second wall 200 and the third wall 300 extending in a direction between the first side surface 103 and the second side surface 104 of the first wall 100, the second wall 200 is pivotably connected to the first wall 100 with the third hinge 201 and the third wall 300 is pivotably connected to the second wall 200 with the fourth hinge 301, the third wall 300 comprises a third wall bottom surface 302 and a third wall top surface 303, the third wall 300 further extending between the third wall bottom surface 302 and the third wall top surface 303, the third wall bottom surface 302 is arranged to be supported on the floor 502 of the road vehicle 500 and the third wall top surface 303 is arranged to supported on the second wall 200.

In one embodiment, the fourth hinge 301 is arranged to transfer a pulling force and a pushing force between the third wall 300 and the second wall 200, and the third wall top surface 303 is arranged to provide a support to a pushing force between the third wall 300 and the second wall 200.

In other words, the fourth hinge 301 and the third wall top surface 303 are arranged to carry a bending moment between the second wall 200 and the third wall 300.

In one embodiment, the fifth hinge 401 is arranged to transfer a pulling force and a pushing force between the fourth wall 300 and the first wall 100, and the fourth wall top surface 403 is arranged to provide a support to a pushing force between the fourth wall 400 and the first wall 100.

In other words, the fifth hinge 401 and the fourth wall top surface 403 are arranged to carry a bending moment between the fourth wall 400 and the first wall 100.

In one embodiment, the furniture 1 further comprises a fourth wall 400 pivotably connected to the first wall 100, the fourth wall 400 extending in a direction between the first side surface 103 and the second side surface 104 of the first wall 100.

In one embodiment, the furniture 1 further comprises a fifth hinge 401.

In one embodiment, the fourth wall 400 is pivotably connected to the first wall 100 with the fifth hinge 401, the fourth wall 400 comprises a fourth wall bottom surface 402 and a fourth wall top surface 403, the fourth wall 400 further extending between the fourth wall bottom surface 402 and the fourth wall top surface 403, the fourth wall bottom surface 402 is arranged to be supported on the floor 502 of the road vehicle 500 and the fourth wall top surface 403 is arranged to be supported the first wall lower surface 102.

In one embodiment, the third hinge 201 is provided in the vicinity of the first wall lower surface 102 or to the first wall lower surface 102.

In one embodiment, the first wall 100 being a plate.

In one embodiment, the first vertical support 10 and the second vertical support 20 being plates or plate.

In an alternative embodiment, the first vertical support 10 and the second vertical support 20 comprise a structure comprising bars.

In one embodiment, the second wall 200 and the third wall 300 being plates.

In one embodiment, fourth wall 400 being plates.

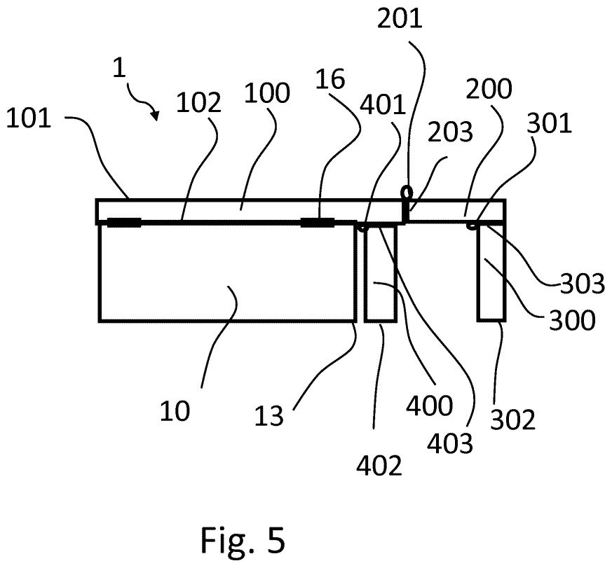

FIG. 5 shows schematically a side view of a furniture according to one embodiment of the present invention.

In this embodiment, the third hinge 201 is provided in the vicinity of the first wall upper surface 101 or to the first wall upper surface 101.

The second wall 200 comprises a second wall side surface 203.

In one embodiment, the third hinge 201 is arranged to transfer a pulling force and a pushing force between the first wall and the second wall 200, and the second wall side surface 203 is arranged to provide a support to a pushing force between the second wall 200 and the first wall 100.

In other words, the third hinge 201 and the second wall side surface 203 are arranged to carry a bending moment between the second wall 200 and the first wall 100.

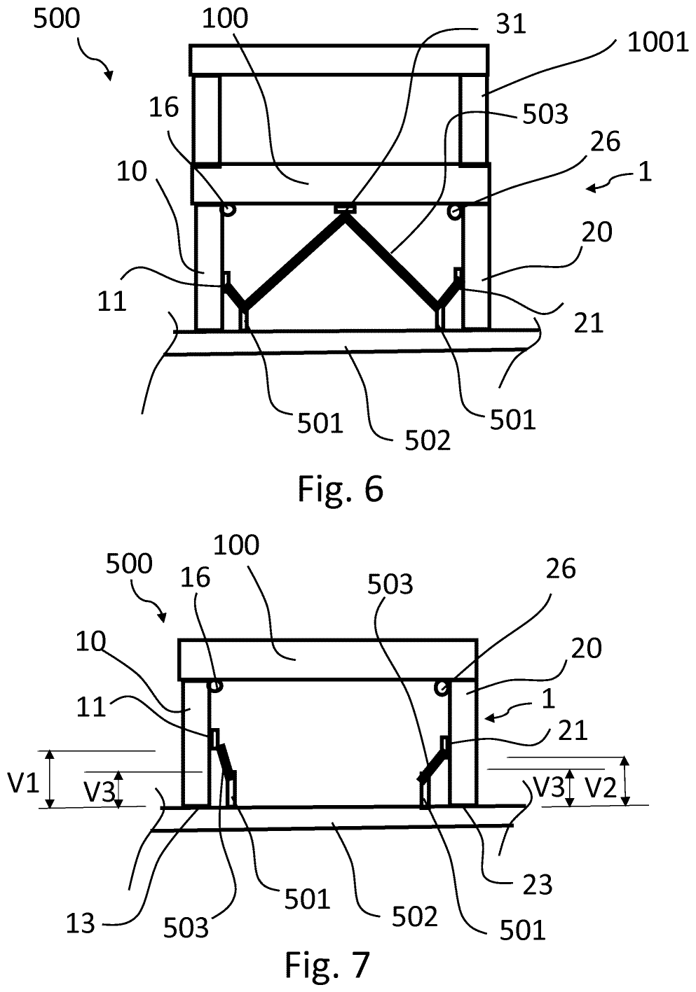

FIG. 6 shows schematically a front view of a furniture of a road vehicle according to one embodiment of the present invention.

The road vehicle 500 comprising a furniture 1, one or more prefabricated cargo fixing parts 501 provided to the floor 502 of the road vehicle 500 and one or more connecting parts 503.

The furniture 1 is releasably mounted to the one or more prefabricated cargo fixing parts 501.

The furniture 1 comprises a first wall 100 positioned in a horizontal direction, a first vertical support 10 positioned in a vertical direction, a second vertical support 20 positioned in a vertical direction, a first mounting arrangement 11 and a second mounting arrangement 21. The first mounting arrangement 11 is releasably mounted to the prefabricated cargo fixing part of the road vehicle 500, the second mounting arrangement 21 is releasably mounted to the prefabricated cargo fixing part of the road vehicle 500. The first vertical support 10 comprises a bottom end of the first vertical support 10 and a top end of the first vertical support 10 at distance from the bottom end of the first vertical support 10. The first vertical support 10 comprising a first bottom support surface 13 provided to the bottom end of the first vertical support 10, the first bottom support surface 13 is releasably supported on the floor 502 of the road vehicle 500. The second vertical support 20 comprises a bottom end of the second vertical support 20 and a top end of the second vertical support 20 at distance from the bottom end of the second vertical support 20. The second vertical support 20 comprising a second bottom support surface 23 provided to the bottom end of the second vertical support 20, the second bottom support surface 23 is releasably supported on the floor 502 of the road vehicle 500. The first vertical support 10 is connected to the first wall 100 at first vertical distance V1 from the first bottom support surface 13, the second vertical support 20 is connected to the first wall 100 at a second vertical distance V2 from the second bottom support surface 23, and the second vertical support 20 is positioned at a sixth horizontal distance H6 from the first vertical support 10. The first and the second vertical distance are shown in FIG. 7. The sixth horizontal distance H6 is shown in FIG. 3.

The sixth horizontal distance H6 being a distance in a direction between the first side surface 103 and the second side surface 104.

In one embodiment, the first mounting arrangement 11 provided to the first vertical support 10, and the second mounting arrangement 21 is provided to the second vertical support 20.

In one embodiment, the one or more connecting parts 503 being flexible.

In one embodiment, the one or more connecting parts 503 being flexible and the one or more connecting parts 503 comprises a tightening part.

In other words, the one or more connecting parts 503 may be a commonly used cargo fixing strap.

In one embodiment, the one or more connecting parts 503 being flexible and the one or more connecting parts 503 comprises a tightening part arranged to provide a tension force to the one or more connecting parts 503.

In one embodiment, the one or more connecting parts 503 comprising one connecting part 503 connecting both the first mounting arrangement 11 and the second mounting arrangement 21 to the one or more prefabricated cargo fixing parts 501.

In an alternative embodiment, the one or more connecting parts 503 comprising one connecting part 503 connecting both the third mounting arrangement 31, the first mounting arrangement 11 and the second mounting arrangement 21 to the one or more prefabricated cargo fixing parts 501.

In another alternative embodiment, the one or more connecting parts 503 comprises two connecting parts 503 connecting the first mounting arrangement 11 and the second mounting arrangement 21 separately to the one or more prefabricated cargo fixing parts 501 as shown in FIG. 7.

In one embodiment, the one or more connecting parts 503 are connected with one or more prefabricated cargo fixing parts 501 between the first vertical support 10 and the second vertical support 20.

FIG. 7 shows schematically a front view of a furniture of a road vehicle according to one embodiment of the present invention.

In one embodiment, the first mounting arrangement 11 and the second mounting arrangement 21 are provided above the one or more prefabricated cargo fixing parts 501.

In one embodiment, the one or more connecting parts 503 being flexible and the one or more connecting parts 503 comprises a tightening part.

In one embodiment, the first mounting arrangement 11 is provided to the first vertical support 10, and the second mounting arrangement 21 provided to the second vertical support 20, the first mounting arrangement 11 is provided at a first vertical distance V1 from the first bottom support surface 13 and the second mounting arrangement 21 is at a second vertical distance V2 from the second bottom support surface 23. The one or more prefabricated cargo fixing parts 501 are provided at a third vertical distance V3 upwards from the floor 502.

In one embodiment, the first vertical distance V1 and the second vertical distance V2 being greater than the third vertical distance V3.

In one embodiment, the road vehicle 500 further comprises an additional furniture 1001, the additional furniture 1001 is positioned over the furniture 1 and connected to the furniture 1.

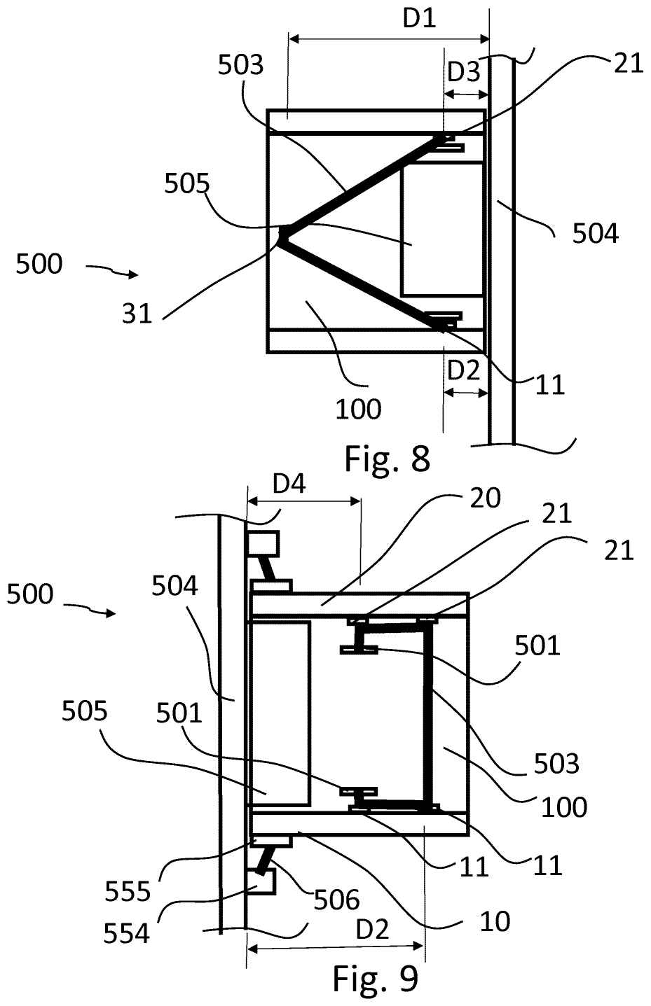

FIG. 8 shows schematically a bottom view of a furniture of a road vehicle according to one embodiment of the present invention.

In one embodiment, the road vehicle 500 comprises a wheel well 505 and a vehicle wall 504, the wheel well 505 is provided in the vicinity of the vehicle wall 504, and the first wall 100 is provided over the wheel well 505.

In one embodiment, the one or more connecting parts 503 are connected with one or more prefabricated cargo fixing parts 501 between the first vertical support 10 and the second vertical support 20.

In one embodiment, the furniture 1 further comprises a third mounting arrangement 31 provided to the first wall 100 at a first distance D1 from the vehicle wall 504, the first mounting arrangement 11 is provided at a second distance D2 from the vehicle wall 504, the second mounting arrangement 21 is provided at a third distance D3 from the vehicle wall 504, the first distance D1 being greater than the second distance D2, and the first distance D1 being greater than the third distance D3.

In other words, the one or more connecting parts 503 are arranged to provide a pushing force between the vehicle wall 504 and the furniture 500.

FIG. 9 shows schematically a bottom view of a furniture of a road vehicle according to one embodiment of the present invention.

In one embodiment, the road vehicle 500 further comprises a vehicle wall 504 and one or more wall connecting parts 506 arranged to mount the furniture 1 to the vehicle wall 504.

In one embodiment, the furniture 1 comprises one or more wall mounting arrangements 555, the road vehicle 500 further comprise one or more prefabricated wall cargo fixing parts 554 provided to the wall 504, the one or more wall connecting parts 506 being flexible and the one or more wall connecting parts 506 comprises a tightening part and the one or more wall connecting parts 506 are arranged to connect the one or more wall mounting arrangements 555 to the one or more prefabricated wall cargo fixing parts 554 provided to the wall 504.

In one embodiment, the furniture comprises two or more the first mounting arrangements 11 and two or more the second mounting arrangement 21. The first mounting arrangements 11 are provided at distance from each other in a direction perpendicular to the third centre line C3. The second mounting arrangements 21 are provided at distance from each other in a direction perpendicular to the third centre line C3 (the third centre line C3 is shown in FIG. 3). In one embodiment, the furniture 1 comprises one or more prefabricated cargo fixing parts 501 provided at a fourth distance D4 from the vehicle wall 504, at least one first mounting arrangement 11 provided at a second distance D2 from the vehicle wall 504, the second distance D2 being greater than the fourth distance D4.

In other words, the one or more connecting parts 503 are arranged to provide a pushing force between the vehicle wall 504 and the furniture 500.

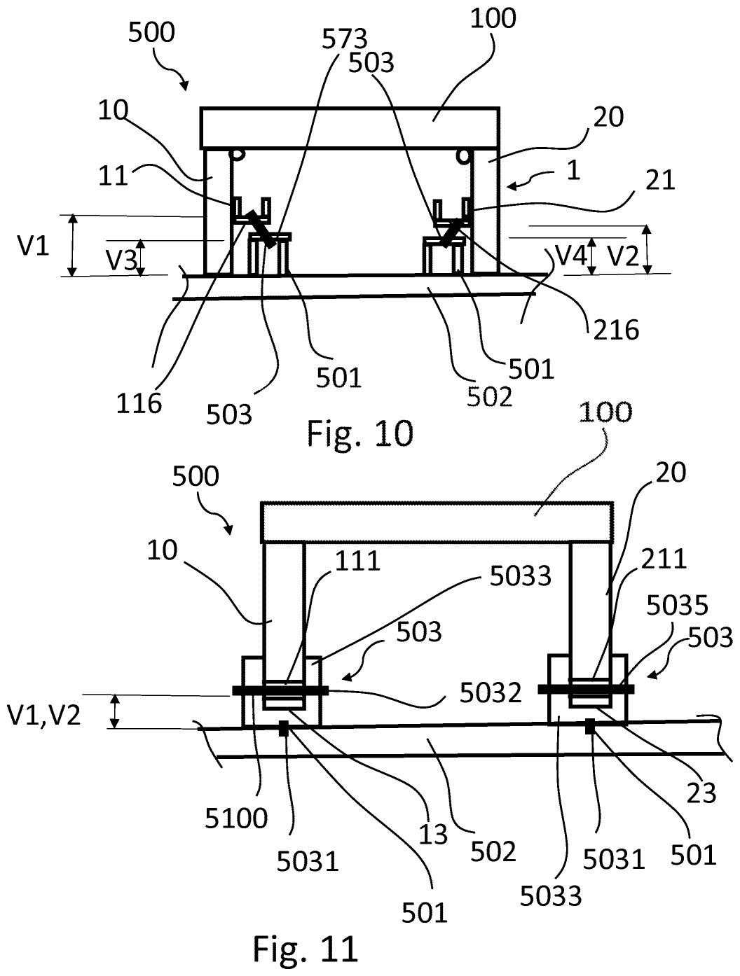

FIG. 10 shows schematically a front view of a furniture of a road vehicle according to one embodiment of the present invention.

The first mounting arrangement 11 comprises a first mounting element 116.

The first mounting element 116 is arranged to transfer a tension force of the one or more connecting parts 503 to the furniture 1. The second mounting arrangement 21 comprises a second mounting element 216. The second mounting element 216 is arranged to transfer a tension force of the one or more connecting parts 503 to the furniture 1. The one or more prefabricated cargo fixing parts 501 comprises a fixing element 573. The fixing element 573 is arranged to a tension force of the one or more connecting parts 503 to the road vehicle 500.

In one embodiment, the first mounting arrangement 11 comprises a hook or a loop or an opening and the second mounting arrangement 21 comprises a hook or a loop or an opening.

In one embodiment, the first mounting element 116 and the second mounting element 216 are above the fixing element 573.

It should be noted that the furniture 1 may be any above disclosed embodiment of the furniture 1.

FIG. 11 shows schematically a front view furniture of a road vehicle 500 according to one embodiment of the present invention.

In this embodiment, the one or more prefabricated cargo fixing parts 501 comprise prefabricated holes comprising a screw thread provided to the floor 502 of the vehicle 500. The one or more connecting parts 503 comprise one or more connecting rails 5032 and one or fixing screws 5031 arranged to secure the one or more connecting rails 5032 to the one or more prefabricated cargo fixing parts 501 comprise prefabricated holes comprising a screw thread.

In one embodiment, the first connecting arrangement 11 comprises one or more first connecting openings 111 provided to the first vertical support 10, the one or more connecting rails 5032 comprises one or more connecting rail opening 5100, the first connecting arrangement 11 comprises one or more first connecting members 5032, and the one or more first connecting members 5032 are arranged to penetrate the one or more connecting rails openings 5100 and the one or more first connecting openings 111.

In one embodiment, the second connecting arrangement 21 comprises one or more first connecting openings 1211 provided to the second vertical support 30, the one or more connecting rails 5032 comprises one or more connecting rail opening 5100, the second connecting arrangement 21 comprises one or more second connecting members 5035, and the one or more second connecting members 5035 are arranged to penetrate the one or more connecting rails openings 5100 and the one or more second connecting openings 211.

In one embodiment, the one or more connecting rails 5032 comprises a cross-section having a U-shape.

In one embodiment, the one or more connecting rails 5032 are arranged to receive the first bottom end 14.

In one embodiment, the one or more connecting rails 5032 are arranged to receive the second bottom end 24.

It should be noted the different embodiments of the furniture 1 shown in FIGS. 3-5 may combined in any possible suitable manner with the different embodiments of FIGS. 1 and 2. Furthermore, the embodiments shown in FIG. 2 may comprise the horizontal support 40 shown in FIG. 1.

It should be noted all the different embodiments of the road vehicle shown in FIGS. 6-11 may combined in any possible suitable manner with the different embodiments shown in said figures.

The present invention provides a use of one or more prefabricated cargo fixing parts 501 provided to a floor 502 of a road vehicle 500 for releasably mounting a furniture 1 to the vehicle, the furniture being any above disclosed embodiment of the furniture 1.

In one embodiment, the road vehicle 500 being any above disclosed embodiment of the road vehicle 500.

The present invention provides a use of a furniture 1 according to any above disclosed embodiment of the furniture 1 as a releasably mounted table or shelf or chair or cabinet or any combination thereof in a road vehicle.

In one embodiment, the road vehicle 500 being any above disclosed embodiment of the road vehicle 500.

The invention has been described above with reference to the examples shown in the figures. However, the invention is in no way restricted to the above examples but may vary within the scope of the claims.

1-20. (canceled)

21. A releasably mountable furniture mountable to a road vehicle comprising a floor and one or more prefabricated cargo fixing parts provided to the floor of the road vehicle, the releasably mountable furniture comprising:
a first wall arranged to be positioned in a horizontal direction,
a first vertical support arranged to be positioned in a vertical direction,
a second vertical support arranged to be positioned in a vertical direction,
a first mounting arrangement arranged to be releasably mounted to the one or more prefabricated cargo fixing parts of the road vehicle, and
a second mounting arrangement arranged to be releasably mounted to the one or more prefabricated cargo fixing parts of the road vehicle,
the first vertical support comprises a first bottom end and a first top end at distance from the first bottom end, the first vertical support extending between the first bottom end and the first top end,
the first vertical support comprising a first bottom support surface provided to the first bottom end, the first bottom support surface is arranged to be releasably supported on the floor of the road vehicle,
the second vertical support comprises a second bottom end and a second top end at distance from the second bottom end, the second vertical support extending between the second bottom end and the second top end,
the second vertical support comprising a second bottom support surface provided to the second bottom end, the second bottom support surface is arranged to be releasably supported on the floor of the road vehicle,
the first vertical support is connected to the first wall at a fifth vertical distance from the first bottom support surface,
the second vertical support is connected to the first wall at a sixth vertical distance from the second bottom support surface, and
the second vertical support is arranged to be positioned at a sixth horizontal distance from the first vertical support.

22. The releasably mountable furniture according to claim 21, wherein:
the first vertical support is secured to the first wall with one or more screws, and the second vertical support is secured to the first wall with one or more screws; or
the first vertical support is secured to the first wall with an interlocking joint, and the second vertical support is secured to the first wall with an interlocking joint; or
the furniture comprises a first hinge and a second hinge, the first hinge is arranged to provide a pivotable connection between the first vertical support and the first wall, and the second hinge is arranged to provide a pivotable connection between the second vertical support and the first wall; or
the furniture comprises a first hinge and a second hinge, the first hinge is arranged to provide a pivotable connection between the first vertical support and the first wall, the second hinge is arranged to provide a pivotable connection between the second vertical support and the first wall, the first vertical support further comprises a first upper surface provided to the first top end, the second vertical support further comprises a second upper surface provided to the second top end, the first wall comprises a first wall upper surface and a first wall lower surface at a distance from the first wall upper surface, the first wall lower surface is arranged to be positioned facing downwards and the first wall upper surface is arranged to be positioned facing upwards, the first upper surface of the first vertical support is arranged to be supported on the first wall lower surface and the second upper surface of the second vertical support is arranged to be supported on the first wall lower surface; or
the furniture comprises a first hinge and a second hinge, the first hinge is arranged to provide a pivotable connection between the first vertical support and the first wall, and the second hinge is arranged to provide a pivotable connection between the second vertical support and the first wall, the first wall further comprises a first side surface and a second side surface, the first wall extending between the first side surface and the second side surface, the first wall is arranged to extend or arranged be extended between the first vertical support and the second vertical support, the first side surface of the first wall is arranged to be supported on the first vertical support and the second side surface of the first wall is arranged to be supported on the second vertical support.

23. The releasably mountable furniture according to claim 22, wherein:
the first wall comprises a first side surface of the first wall, a second side surface of the first wall, the second side surface extending at a distance from the first side surface, the first side surface and the second side surface of the first wall extending between the first wall upper surface and the first wall lower surface, the first upper surface of the first vertical support is arranged to be positioned to extend between the first hinge and the first side surface of the first wall and the second upper surface of the second vertical support is arranged to be positioned to extend between the second hinge and the second side surface of the first wall; or
the first wall comprises a first side surface of the first wall, a second side surface of the first wall, the second side surface extending at a distance from the first side surface, the first side surface and the second side surface of the first wall extending between the first wall upper surface and the first wall lower surface, the first upper surface of the first vertical support is arranged to be positioned to extend between the first hinge and the first side surface of the first wall in the vicinity of the first side surface of the first wall, and the second upper surface is arranged to be positioned to extend between the second hinge and the second side surface of the first wall in the vicinity of the second side surface; or
the first wall comprises a first side surface of the first wall, a second side surface of the first wall, the second side surface extending at a distance from the first side surface, the first side surface and the second side surface of the first wall extending between the first wall upper surface and the first wall lower surface, the first upper surface is arranged to be positioned to extend between the first hinge and the second side surface of the first wall in the vicinity of the first side surface of the first wall, and the second upper surface is arranged to be positioned to extend between the second hinge and the first side surface of the first wall in the vicinity of the second side surface of the first wall.

24. The releasably mountable furniture according to claim 21, wherein:
the first vertical support comprises a first vertical support front surface, the second vertical support comprises a second vertical support front surface, the a first vertical support front surface is arranged to face or arranged to be positioned to face towards the second vertical support, the second vertical support front surface is arranged to face or arranged to be positioned to face towards the first vertical support, the first mounting arrangement is connected to the first vertical support front surface, and the second mounting arrangement is connected to the second vertical support front surface; or
the first vertical support comprises a first vertical support front surface, the second vertical support comprises a second vertical support front surface, the a first vertical support front surface is arranged to face or arranged to be positioned to face in a direction away from the second vertical support, the second vertical support front surface is arranged to face or arranged to be positioned to face in a direction away from the first vertical support, the first mounting arrangement is connected to the first vertical support front surface, and the second mounting arrangement is connected to the second vertical support front surface.

25. The releasably mountable furniture according to claim 21, wherein:
the first mounting arrangement is provided to the first vertical support, and the second mounting arrangement is provided to the second vertical support; or
the first mounting arrangement and the second mounting arrangement are provided to the first wall; or
the first mounting arrangement is provided to the first vertical support, and the second mounting arrangement is provided to the second vertical support, the first mounting arrangement is provided at a first vertical distance from the first bottom support surface and the second mounting arrangement is at a second vertical distance from the second bottom support surface; or
the first mounting arrangement is provided to the first vertical support, and the second mounting arrangement provided to the second vertical support, the first vertical support having a first centre line extending in a direction between the first bottom support surface and first upper surface, the first hinge and the first mounting arrangement are positioned on the same side of the first centre line in a direction between the first vertical support and the second vertical support; or
the first mounting arrangement is provided to the first vertical support, and the second mounting arrangement is provided to the second vertical support, the first vertical support having a first centre line extending in a direction between the first bottom support surface and first upper surface, a first hinge and the first mounting arrangement are positioned on the same side of the first centre line in a direction between the first vertical support and second vertical support, the second vertical support having a second centre line extending in a direction between the second bottom support surface and the second upper surface, the second hinge and the second mounting arrangement are positioned on the same side of the second centre line in a direction between the first vertical support and second vertical support, the first mounting arrangement is provided at a first vertical distance from the first bottom support surface and the second mounting arrangement is at a second vertical distance from the second bottom support surface.

26. The releasably mountable furniture according to claim 21, wherein:
the furniture further comprises a second wall connected to the first wall, the second wall is arranged to be positioned to extend horizontally in a direction between the first side surface and the second side surface of the first wall; or
the furniture further comprises a second wall pivotably connected to the first wall, the second wall extending in a direction between the first side surface and the second side surface of the first wall; or
the furniture further comprises a second wall pivotably connected to the first wall, a third wall pivotably connected to the second wall, and the second wall and the third wall extending in a direction between the first side surface and the second side surface of the first wall; or
the furniture further comprises a third hinge, a fourth hinge, a second wall and a third wall, and the third wall extending in a direction between the first side surface and the second side surface of the first wall the second wall is pivotably connected to the first wall with the third hinge and the third wall is pivotably connected to the second wall with the fourth hinge; or
the furniture further comprises a third hinge, a fourth hinge, a second wall and a third wall, and the second wall and the third wall extending in a direction between the first side surface and the second side surface of the first wall, the second wall is pivotably connected to the first wall with the third hinge and the third wall is pivotably connected to the second wall with the fourth hinge, the third wall comprises a third wall bottom surface and a third wall top surface, the third wall further extending between the third wall bottom surface and the third wall top surface, the third wall bottom surface is arranged to be supported on the floor of the road vehicle and the third wall top surface is arranged to supported on the second wall.

27. The releasably mountable furniture according to claim 21, wherein:
the furniture further comprises a fourth wall pivotably connected to the first wall, the fourth wall extending in a direction between the first side surface and the second side surface of the first wall; or
the furniture further comprises a fourth wall pivotably connected to the first wall and a fifth hinge, the fourth wall extending in a direction between the first side surface and the second side surface of the first wall, the fourth wall is pivotably connected to the first wall with the fifth hinge, the fourth wall comprises a fourth wall bottom surface and a fourth wall top surface, the fourth wall further extending between the fourth wall bottom surface and the fourth wall top surface, the fourth wall bottom surface is arranged to be supported on the floor of the road vehicle and the third wall top surface is arranged to supported the first wall lower surface.

28. The releasably mountable furniture according to claim 21, wherein:
the first wall being a plate; or
the first wall, the first vertical support and the second vertical support being plates; or
the first wall, the second wall, the third wall, the first vertical support and the second vertical support being plates; or
the first wall, the second wall, the third wall, the fourth wall, the first vertical support and the second vertical support being plates.

29. The releasably mountable furniture according to claim 21, wherein:
the furniture being a table, or a shelf or a chair, or a cabinet or any combination thereof.

30. The releasably mountable furniture according to claim 21, wherein:
the furniture further comprises a horizontal support; or
the furniture further comprises a horizontal support, the first vertical support and the second vertical support are arranged to be connected with the horizontal support; or
the furniture further comprises a horizontal support arranged to be connected to a prefabricated part of a wall of the road vehicle.

31. The releasably mountable furniture according to claim 21, wherein:
the furniture further comprises a third mounting arrangement provided to the first wall; or
the furniture further comprises a third mounting arrangement provided to the first wall, the furniture having a third centre line extending in a direction between the first vertical support and the second vertical support, the third mounting arrangement is provided to an opposite side of the third centre line than the first mounting arrangement and the second mounting arrangement.

32. A road vehicle, wherein:
the road vehicle comprises a furniture, a floor, one or more prefabricated cargo fixing parts provided to the floor of the road vehicle and one or more connecting parts,
the furniture is releasably mounted to the one or more prefabricated cargo fixing parts with the one or more connecting parts,
the furniture comprises:
a first wall, the first wall extending in a horizontal direction,
a first vertical support, the first vertical support extending in a vertical direction,
a second vertical support, the second vertical support extending in a vertical direction,
a first mounting arrangement, the first mounting arrangement is releasably mounted to the one or more prefabricated cargo fixing part of the road vehicle with the one or more connecting parts, and
a second mounting arrangement, the second mounting arrangement is releasably mounted to the one or more prefabricated cargo fixing part of the road vehicle with the one or more connecting parts,
the first vertical support comprises a first bottom end and a first top end at distance from the first bottom end,
the first vertical support comprising a first bottom support surface provided to first bottom end the first bottom support surface is releasably supported on the floor of the road vehicle,
the second vertical support comprises a second bottom end and a second top end at distance from the second bottom end,
the second vertical support comprises a second bottom support surface provided to the second bottom end, the second bottom support surface is releasably supported on the floor of the road vehicle,
the first vertical support is connected to the first wall at a fifth vertical distance from the first bottom support surface,
the second vertical support is connected to the first wall at a sixth vertical distance from the second bottom support surface, and
the second vertical support is positioned at a sixth horizontal distance from the first vertical support.

33. The road vehicle according to claim 32, wherein:
the road vehicle comprises a wheel well and a vehicle wall, the wheel well is provided in the vicinity of the vehicle wall, and the first wall is provided over the wheel well; or
the one or more connecting parts are connected to the one or more prefabricated cargo fixing parts; or
the one or more connecting parts are secured to the one or more prefabricated cargo fixing parts between the first vertical support and the second vertical support; or
the road vehicle comprises a wheel well and a vehicle wall, the wheel well is provided in the vicinity of the vehicle wall, the first wall is provided over the wheel well, and the one or more connecting parts are secured to the one or more prefabricated cargo fixing parts between the first vertical support and the second vertical support; or
the road vehicle comprises a wheel well and a vehicle wall, the wheel well is provided in the vicinity of the vehicle wall, the first wall is provided over the wheel well, the one or more connecting parts are secured to the one or more prefabricated cargo fixing parts between the first vertical support and the second vertical support, the furniture further comprises a third mounting arrangement provided to the first wall at a first distance from the vehicle wall, the first mounting arrangement is provided at a second distance from the vehicle wall, the second mounting arrangement is provided at a third distance from the vehicle wall, the first distance being greater than the second distance, and the first distance being greater than the third distance.

34. The road vehicle according to claim 32, wherein:
the road vehicle further comprises a vehicle wall and one or more wall connecting parts arranged to mount the furniture to the vehicle wall; or
the road vehicle further comprises a vehicle wall comprising a frame and one or more wall connecting parts, and the one or more wall connecting parts are arranged to mount the furniture to the frame of the vehicle wall; or
the road vehicle further comprises a vehicle wall and one or more wall connecting parts arranged to mount the furniture to the vehicle wall, the furniture comprises one or more wall mounting arrangements, the road vehicle further comprise one or more prefabricated wall cargo fixing parts provided to the wall, the one or more wall connecting parts being flexible and the one or more wall connecting parts comprises a tightening part and the one or more wall connecting parts are arranged to connect the one or more wall mounting arrangements to the one or more prefabricated wall cargo fixing parts provided to the wall.

35. The road vehicle according to claim 32, wherein:
the one or more connecting parts comprises one or more connecting rails; or
the one or more connecting parts being flexible; or
the one or more connecting parts being flexible and the one or more connecting parts comprises a tightening part; or
the first mounting arrangement and the second mounting arrangement are provided above the one or more prefabricated cargo fixing parts; or
the first mounting arrangement and the second mounting arrangement are provided above the one or more prefabricated cargo fixing parts and the one or more connecting parts being flexible; or
the first mounting arrangement and the second mounting arrangement are provided above the one or more prefabricated cargo fixing parts, the one or more connecting parts being flexible and the one or more connecting parts comprises a tightening part.
